(19) United States
(12) Patent Application Publication
(10) Pub. No.: US 2009/0148209 A1
(43) Pub. Date: Jun. 11, 2009

(54) DOUBLE-SIDED RECORDING APPARATUS

(75) Inventor: Akihiko IKEGAMI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/328,911

(22) Filed: Dec. 5, 2008

(30) Foreign Application Priority Data
Dec. 6, 2007 (JP) 2007-315488

(51) Int. Cl. G03G 15/00

(52) U.S. Cl. 399/364

(57) ABSTRACT

A double-sided image forming apparatus includes a line-recording front-side image forming apparatus and a line-recording rear-side image forming apparatus which are arranged in a transportation direction of a recording medium, in which each of the front-side image forming apparatus and the rear-side image forming apparatus includes a drum, a roller having a smaller diameter than the drum, an endless belt wound around the drum and the roller, a driving power source which transports the belt by rotating the drum, and a line-recording recording unit placed to face an outer circumferential surface of the drum so as to be able to perform recording with respect to the recording medium which is laid on the outer circumferential surface of some portion of the belt which is wound around the drum.

### BACKGROUND

1. Technical Field

The present invention relates a double-sided image forming apparatus composed of a line-recording front-side image forming apparatus, such as a line printer, and a line-recording rear-side image forming apparatus, such as a line printer.

2. Related Art

JP-A-2003-94615 (paragraphs 0029 to 0041 and FIG. 4) discloses a printer which records letters and/or images on recording paper using an ink-jet recording head by attaching the recording paper to a rotating drum and rotationally transporting the recording paper at constant speed in order to stabilize transportation speed of the recording paper when performing printing. This printer is provided with a grip mechanism which holds a leading end of the recording paper. The printer is structured in a manner such that the drum is charged by a corona charger in order to transport the recording paper in a state in which the entire body of the recording paper is in close contact with the drum, and the drum is discharged by driving a separation charger as soon as the grip mechanism releases the recording paper in order to separate the recording paper from the drum and discharge the recording paper out of the printer. To practically discharge the recording paper, an additional mechanism such as a vacuum belt transport is provided in the printer.

JP-A-2005-280192 (for example, paragraphs 0013 and 0014, FIG. 2) and JP-A-2007-76872 (for example, paragraphs 0018 to 0021, FIG. 1) disclose a line printer (line-type ink-jet recording apparatus) in which recording paper is transported while it is placed on a belt wound around a pair of rollers. In such a line printer, a plurality of heads is arranged to face a portion of an upper surface of the belt which is disposed between the rollers. Recording by the line printer is performed by discharging ink droplets discharged from the line heads to the recording paper which is adsorbed to the belt in an electrostatic manner or in a negative pressure adsorbing manner.

However, the printer disclosed in JP-A-2003-94615 has a problem in that a large-sized structure such as the grip mechanism which grips the leading end of the recording paper is needed. Further, the drum must be electrically charged by the corona charger in order to transport the entire recording paper while maintaining the recording paper to stay in a close contact with the drum, and complicated operations are needed to discharge the drum by driving the separation charger as soon as the grip mechanism disengages the recording paper in order to separate and discharge the recording paper from the drum. Further, an additional mechanism, such as the vacuum belt transport, is also required in order to practically discharge the recording paper. Accordingly, it is inevitable for the entire structure of the printer become large in volume.

In printers disclosed in JP-A-2005-280192 and JP-A-2007-76872, the recording paper is adsorbed to the surface of the belt. However, since the printing is performed at a position of the recording paper disposed on the belt stretched between rollers, the belt is likely to shake and therefore ink droplets are likely to be driven to and land on the recording paper which is shaking. With the structure in which the belt is stretched between rollers in the first place, it is hard to expect for the belt and rollers which support and transport the recording paper to have high inertia. Accordingly, speed change occurs easily. For such reasons, positional precision of ink dots varies easily and it is difficult to obtain high print quality.

In the case of performing double-sided recording on the recording paper using the above-described structure, the following problems may occur. For example, according to the former drum-type structure, two drums are arranged to abut against each other as utilized in an offset printer and the recording paper is delivered by the grip mechanism. In this structure, since the two drums directly abut against each other, the recording paper is wound around the drum used for the rear-side recording in a state in which ink placed on the front side of the recording paper in the front-side recording is not sufficiently dried, and therefore the image quality of the front side deteriorates.

According to the later belt-type structure, the problem with deterioration of the recording quality which is attributable to vibration of the belt results in the quality deterioration of the double-sided recording.

### SUMMARY

An advantage of some aspects of the invention is to provide a line-recording double-sided image forming apparatus which can transport a recording medium in a relatively simple manner and achieve high precision of recording position by stably transporting the recording medium when performing a recording by a recording unit.

According to one aspect of the invention, there is provided a double-sided image forming apparatus including a line-recording front-side image forming apparatus and a line-recording rear-side image forming apparatus, in which each of the front-side image forming apparatus and the rear-side image forming apparatus includes a drum, a roller having a smaller diameter than the drum, an endless belt wound around the drum and roller, a driving source which transports the belt by rotating the drum, and a line-recording recording unit arranged to face an external circumferential surface of the drum so that recording is performed to a portion of a recording medium which is placed on the circumferential surface of the belt wound around the drum, and in which, of the recording medium transported in a state in which it is placed on the surface of the belt of the front-side image forming apparatus, a portion of the recording medium having passed a position of the recording unit is delivered in a manner such that the portion of the recording medium is transported to the outer circumferential surface of a portion of the belt which is wound around the drum which is at the upstream side in the rear-side image forming apparatus by the recording unit.

The “drum” does not mean only a drum which is used in a manner such that the recording medium is directly in contact with the surface of the drum, the surface of the drum is used as a platen, and the recording is performed on the surface of the drum (in a slick, curved form). That is, the drum may be other structures in which the recording is performed on the surface of the belt in a state in which the belt is wound around the drum as in the known technique. For example, the drum may also be a structure in which a shape of the surface of the drum is not slick.

With this structure, the line-recording recording unit performs the recording with respect to the recording medium which is fed, and particularly to a portion of the recording medium placed on the outer circumferential surface of the portion of the belt wound around the drum. The drum has a larger diameter than the roller. Accordingly, in the case in which the drum rotates at constant speed, a stable rotation thereof can be achieved. For such a reason, the portion of the recording medium which is transported as it is placed on the drum via the belt is stably transported without vibration, and the speed change and the recording is performed with respect to the portion of the recording medium which is stably transported. Accordingly, it is possible to ensure high precision in recording positions and facilitate high quality double-sided recording. Further, since the recording medium is transported by the belt, the transportation mechanism for transporting the recording medium is very simple. Since the mass of the drum affects the inertia, it is preferable that the outer diameter of the drum is set so that the drum more strongly affects movement of the belt than the roller when considering in terms of the mass.

In the case in which the recording unit adopts a serial recording system, the drum must be intermittently driven in order to intermittently transport the recording medium. In such a case, a higher inertia brings about deterioration of precision in stop position. However, since the line-recording system is adopted as the recording unit, stable transportation of the recording medium can be achieved by just rotating the drum at constant speed during the recording, and therefore it is possible to obtain excellent effects.

In the double-sided image forming apparatus, it is preferable that a delivery portion at which the recording medium is delivered is designed in a manner such that the recording medium is in plane contact with a predetermined portion of each of the belts of the front-side image forming apparatus and the rear-side image forming apparatus.

With this structure, the delivery portion at which delivery of the recording medium is performed is designed to be in plane contact with a predetermined area of the surface of each of the belts of the front-side image forming apparatus and the rear-side image forming apparatus along the transportation direction. Accordingly, at the delivery portion, the recording medium is in a state in which it is supported from the upside and the underside thereof by the belts. After this state, the recording medium drops into a state in which it is supported only by the belt of the rear-side recording image forming apparatus. Accordingly, the recording medium is smoothly delivered from the upper surface of the front-side image forming apparatus to the upper surface of the rear-side image forming apparatus, and therefore it is possible to prevent lowering of the recording quality which is attributable to the poor delivery.

In the double-sided image forming apparatus, it is preferable that at least the rear-side image forming apparatus includes one drum and two rollers; the delivery portion is disposed at an area between a roller of the front-side image forming apparatus which forms a separation portion of the recording medium and a roller of the rear-side image forming apparatus which forms an introduction portion of the recording medium; an angle of the belt, which is wound around the roller, with respect to the roller forming the separation portion is an acute angle; and an angle of the belt, which is wound around the roller, with respect to the roller forming the introduction portion is an obtuse angle.

With this structure, at least the rear-side image forming apparatus includes one drum and two rollers. Accordingly, since the image forming apparatus has a three-axis structure, the degree of design freedom increases and therefore it is possible to reserve a space for installing a dry unit which will be described later and other parts. The front-side image forming apparatus also may have a three-axis structure including one drum and two rollers.

The deliver portion is disposed at an area between the roller of the front-side image forming apparatus which forms the separation portion and the roller of the rear-side image forming apparatus which forms the introduction portion, the angle of the belt wound around the roller forming the separation portion is an acute angle, and the angle of the belt wound around the roller forming the introduction portion is an obtuse angle. Accordingly, when the recording medium with the front-side surface on which the recording is performed by the front-side image forming apparatus approaches to the delivery portion so as to be delivered to the rear-side image forming apparatus, even if the leading end of the recording medium is lifted, the lifting of the recording medium is easily corrected by the obtuse angle and the recording medium enters the delivery portion in the corrected posture.

In the double-sided image forming apparatus, it is preferable that transportation speed of the belt of the rear-side image forming apparatus is higher than transportation speed of the belt of the front-side image forming apparatus.

In typical printers, the transportation speeds of the belts of the front-side image forming apparatus and the rear-side image forming apparatus are equal to each other and the front-side and rear-side image forming apparatuses are synchronously driven. Accordingly, at the deliver portion, although the recording medium receives transportation force from both belts, the delivery mismatching must not occur. However, in actual practice, it is neither simple nor easy to set the speeds to be perfectly identical. Accordingly, there can be the speed difference between both belts. The speed difference leads to jamming.

With this structure, since the belt speeds are set such that the transportation speed of the belt of the rear-side image forming apparatus is higher than the transportation speed of the belt of the front-side image forming apparatus, it is possible to prevent jamming from occurring.

In the double-sided image forming apparatus, it is preferable that a dry unit is disposed at an area between the recording unit of the front-side image forming apparatus and the roller of the rear-side image forming apparatus which forms the introduction portion.

With this structure, since the transportation speed of the belt of the rear-side image forming apparatus is set to be higher than the transportation speed of the belt of the front-side image forming apparatus, contact load with respect to the recording-finished surface of the recording medium attributable to the speed difference might increase, but it is possible to prevent recording quality deterioration attributable to the increase of the contact load by drying the recording surface in advance by the recording unit.

In the double-sided image forming apparatus, it is preferable that a diameter of the drum is three (3) to ten (10) times larger than the roller.

With this structure, since the diameter of the drum is within a range of 3 to 10 times of the diameter of the roller, it is possible to avoid having the apparatus with a large volume attributable to the large diameter of the drum. Further, since the drum has a sufficiently higher inertia than the roller, it is possible to transport the portion of the recording medium which is wound the drum. Accordingly, precision of the transportation position of the recording medium is improved and it is possible to effectively improve precision of the recording position with respect to the recording medium.

In the double-sided image forming apparatus, it is preferable that at least a portion of the belt which is wound around the drum has a negative pressure unit which adsorbs the recording medium.

With this structure, at least at the portion of the belt wound around the drum, since the recording medium is adsorbed to the upper surface of the belt by a negative pressure generated by the negative pressure unit, it is possible to effectively prevent position misalignment of the recording medium with respect to the outer circumferential surface of the drum which is stably driven from occurring. Accordingly, it becomes easy to obtain high precision in the recording position by effectively avoiding the position misalignment of the recording medium with respect to the drum (or belt).

In the double-sided image forming apparatus, it is preferable that the front-side recording apparatus has a space disposed at a more inner side than the inner circumferential surface of the belt and disposed outside the drum in which the space is provided with a barrier wall portion which demarcates a portion of the space in which suction force can be imparted to the adsorption holes of the portion of the belt ranging from an ending point of the winding of the belt with respect to the drum to a beginning point of the winding of the belt with respect to the roller by the negative pressure caused by discharging the air in the drum out of the drum through the adsorption holes of the drum; and the rear-side recording apparatus has a space disposed at a more inner side than the inner circumferential surface of the belt and disposed outside the drum, in which the space is provided with a barrier wall portion which demarcates a portion of the space in which adsorption force can be imparted to the adsorption holes 115a of the portion of the belt ranging from an ending point of the winding of the belt with respect to the drum to a beginning point of the winding of the belt with respect to the roller by the negative pressure caused by discharging the air in the drum out of the drum through the adsorption holes of the drum; and the spaces surrounded by at least the barrier wall portions and the belts are sealed.

With this structure, the space disposed at more inner side than the inner circumferential surface of the belt and disposed outside the drum (the space inside the belt which can communicate with the drum through the adsorption holes). Further it is possible to concentrate the negative pressure to the adsorption holes of some portion of the belt on which the recording medium is transported, the portion ranging from a downstream side of the winding of the belt wound around the drum to a position of the belt wound around the roller in the case of the front-side image forming apparatus and the portion ranging from a downstream side of the winding of the belt wound around the drum to a position of the belt wound around the roller in the case of the rear-side image forming apparatus.

### BRIEF DESCRIPTION OF THE DRAWINGS

The invention will be described with reference to the accompanying drawings, wherein like numbers reference like elements.

FIG. 1 is a schematic side-sectional view illustrating main part of a double-sided image forming apparatus according to a first embodiment of the invention.

FIG. 2 is a plan view illustrating a portion of a front-side recording apparatus of FIG. 1.

FIG. 3 is a schematic side-sectional view illustrating a portion of a front-side recording apparatus according to a second embodiment of the invention.

FIG. 4 is a schematic side view illustrating the front-side recording apparatus according to the second embodiment.

FIG. 5 is a schematic side plan view illustrating the front-side recording apparatus according to the second embodiment.

FIG. 6 is a schematic side-sectional view illustrating part of a double-sided image forming apparatus according to a third embodiment of the invention.

### DESCRIPTION OF EXEMPLARY EMBODIMENTS

### First Embodiment

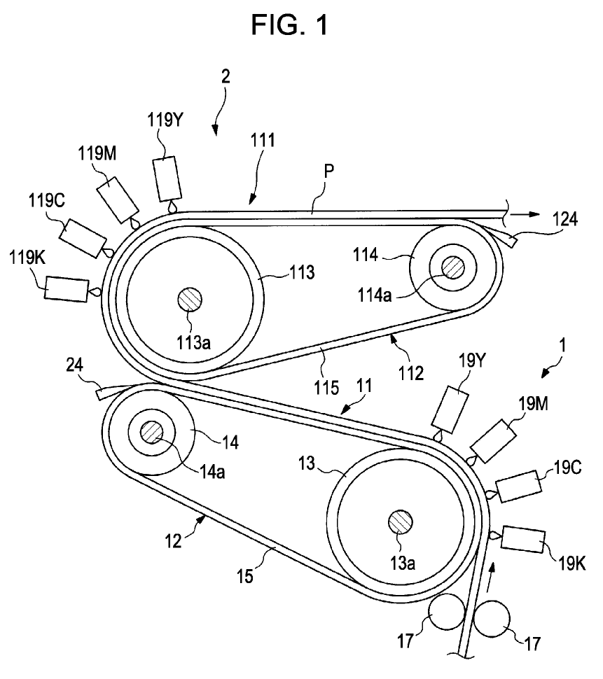

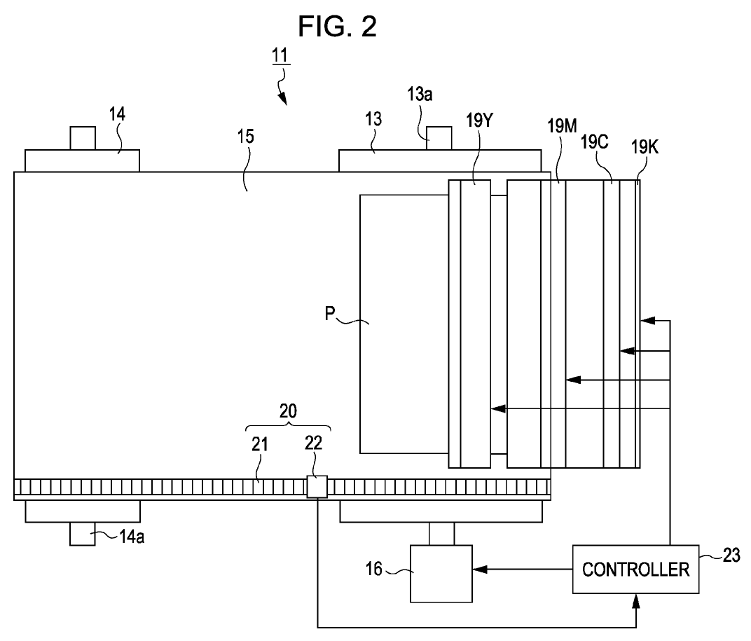

Hereinafter, embodiments of the invention will be described with reference to the accompanying drawings FIG. 1 and FIG. 2.

FIG. 1 shows a double-sided image forming apparatus including an ink-jet, line-recording front-side recording apparatus and an ink-jet, line-recording rear-side recording apparatus. FIG. 2 shows a portion of the front-side recording apparatus of FIG. 1. In FIG. 1, a direction from a lower position to a left position and from the left position to a right position is a transportation direction of paper. FIG. 2 shows a state in which recording paper is in a transportation position after printing begins.

As shown in FIG. 1, the double-sided image forming apparatus according to this embodiment includes a line-recording front-side recording apparatus 1 and a line-recording rear-side recording apparatus 2 which are arranged in a transportation direction of recording paper P. In this embodiment, the front-side recording apparatus 1 and the rear-side recording apparatus 2 basically have the same structure as each other. The basic structure will be described below.

As shown in FIGS. 1 and 2, a line printer (simply referred to as printer 11) serving as the front-side recording apparatus 1 includes a belt transportation apparatus 12 for transporting the recording paper P. The belt transportation apparatus 12 includes a driving drum disposed at an upstream side in the paper transportation direction (referred to as drum 13), a driven roller disposed at a downstream side in the paper transportation direction (referred to as roller 14), and an endless transportation belt engaging the drum 13 and the roller 14 (referred to as belt 15). Rotation shafts 13a and 14a of the drum 13 and the roller 14 are rotatably supported by bearings.

The drum 13 has the same surface form and diameter as the known-structured drum in which the surface of the drum is in direct contact with the recording paper P and recording is performed on the surface (in slick and curved form) of the drum as using the surface of the drum as a platen. Alternatively, the structure of the drum 13 may not be limited thereto. That is, the drum may have any structures as long as the structure enables the recording, which was performed on the drum surface having the slick curved shape, to be performed on the surface of the belt 15 which is wound around the drum 13 because the belt 15 is wound around the drum 13. Accordingly, the drums of which the surfaces are not slick can also be used.

The drum 13 is connected to an output shaft of an electric motor 16 shown in FIG. 2 directly or via a decelerating mechanism (not shown) so that driving force can be transferred. When the electric motor 16 which is a driving power source is driven forward, the drum 13 is rotated and therefore the belt 15 rotates the recording paper P in the transportation direction from the upstream side to the downstream side. A pair of gate rollers 17 constituting a paper feeding unit is disposed at a proximal position under the drum 13 at the upstream side in the transportation direction in the belt transportation apparatus 12. The recording paper P is fed to the upper surface of the belt 15 wound around the drum 13 by the gate rollers 17.

The gate rollers 17 correct the skew of the recording paper P by causing the recording paper P to strike the surface of the rollers, and sends the recording paper P so that the recording paper P is placed on a target position on the belt 15 at proper timing by adjusting drive start timing. For example, the belt 15 is an endless type in which both ends of a belt-like member are connected to each other, and the recording paper P is sent not to poke the seam of the belt 15.

The belt 15 is made of rubber. The belt 15 can maintain the recording paper P thereon because the surface of the belt made of rubber has adherence. It is possible to maintain the recording paper P at the surface of the belt 15 by a known electrostatic adsorption manner or a negative pressure adsorption manner.

Four line-recording recording heads (line heads 19Y, 19M, 19C, and 19K) serving as the recording units are placed to face the outer circumferential surface of the drum 13 at the outer and upper position of the drum 13, and arranged along the outer circumferential surface of the drum 13 at a regular gap between them. The four line heads 19Y, 19M, 19C, and 19K discharge four colors of ink droplets, yellow Y, magenta M, cyan C, and black K. The ink to be discharged is supplied through an ink supply tube from each of ink tanks (not shown).

Each of the line heads 19Y, 19M, 19C, and 19K has a length by which recording can be performed over the maximum width of the paper, and a plurality of nozzles is arranged in a direction (nozzle column direction) which intersects the transportation direction of the recording paper P. Fine ink dots are formed on the recording printer P by simultaneously discharging ink droplets of the desired amount to desired positions from the nozzles. As such an operation is performed for each of colors, it is possible to record letters and images onto the recording paper P in one pass in which recording is performed by causing the recording paper P on the belt 15 to pass through a transportation path between each of the line heads 19Y, 19M, 19C, and 19K and the belt 15 just once.

The number of needed colors of line heads 19Y, 19M, 19C, and 19K may be structured in a single head form or as a multi-head form in which a plural number of unit heads is arranged in a line form in a direction which intersects the transportation direction so that the whole of the line heads 19Y, 19M, 19C, and 19K serve like a single line head. The plural number of unit heads is positioned at different places in a direction (paper width direction) which intersects the transportation direction. Alternatively, at least some of the unit heads may be placed at different positions in the transportation direction as long as the printing can be performed over the entire width of the paper by the plural number of unit heads. In the case of indiscriminating ink colors, the line heads 19Y, 19M, 19C, and 19K may be inscribed by a line head 19 in the lump.

As shown in FIG. 2, a magnetic linear encoder 20 is disposed at a side edge of the belt 15. The magnetic linear encoder 20 is composed of a magnetic linear scale 21 formed over the whole circumference of a belt and a magnetic sensor 22 which detects and reproduces magnetic patterns with magnetized portions with a predetermined pitch therebetween on the surface of the magnetic linear scale 21. The magnetic sensor 22 outputs an encoder signal (pulses) composed of a number of pulses which is proportional to rotation amount of the belt 15. The controller 23 serving as a control unit disposed in the printer 11 controls the electric motor 16 to rotate at constant speed according to a recording mode on the basis of the encoder signal output from the magnetic sensor 22. Further, the controller 23 controls the recording head so that the recording head ejects ink droplets at proper timing which is set to match with a paper transportation position on the basis of recording reference pulse (ejection timing signals) generated on the basis of the encoder signal in an internal circuit.

FIGS. 1 and 2 schematically show a ratio of a diameter of the drum 13 to a diameter of the roller 14. Practically, the drum 13 according to this embodiment has a diameter which is larger 3 to 10 times larger than the diameter of the roller 14. For example, when the diameter of the roller is 3 cm, it is preferable that the diameter of the drum 13 is 9 to 30 cm. Such a diameter ratio is set in order to stably rotate the drum 13 while ensuring the high inertia by increasing the diameter of the drum 13 and to securely reserve an arrangement area for the line heads 19Y, 19M, 19C, and 19K which perform a printing on the outer circumferential surface of the drum.

Further, since mass of the drum 13 affects the inertia, it is preferable that the outer diameter of the drum 13 is set such that the drum 13 more significantly affects operation of the belt 15 than the roller 14.

When the recording paper P is transported along the surface of the belt 15 and reaches the roller 14, the recording paper P must be separated from the surface of the belt 15. With this example, however, the recording paper P is separated by its intrinsic stiffness and a curvature of a portion of the belt 15 wound around the roller 14. The curvature of the belt 15 is determined to achieve curvature separation of the recording paper P by the stiffness of the recording paper P and the diameter of the roller 14 is determined to obtain such curvature. Separation pawls 24 for compulsively separating the recording paper P are placed at a relatively downstream side position in the transportation direction in comparison with a position at which curvature separation of the recording paper P occurs. A plurality of the separation pawls 24 is disposed in parallel with one another in the width direction of the belt 15, and the recording paper P is separated from the belt 15 when a portion of the recording paper P, which is not separated by curvature separation, and comes into contact with the plurality of pawls arranged in the paper width direction. Alternatively, the separation pawls 24 may be disposed at a position where the curvature separation of the recording paper P occurs.

Next, the line printer (hereinafter, referred to as a printer 111) serving as the rear-side recording apparatus 2 is equipped with a belt transportation apparatus 112 having the same structure as the belt transportation apparatus of the front-side recording apparatus 1. The belt transportation apparatus 112 includes a driving drum (hereinafter, referred to as a drum 113) disposed at an upstream side in the paper transportation direction, a driven roller (hereinafter, referred to as a roller 114) disposed at a downstream side in the paper transportation direction, and an endless transportation belt (hereinafter, simply referred to as a belt 115) wound around the drum 113 and the roller 114 to run from the drum 113 to the roller 114. Rotation shafts 113a and 114a of the drum 113 and the roller 114 are supported by bearings (not shown) in a rotatable manner.

The rear-side recording apparatus is further equipped with line heads 119Y, 119M, 119C, and 119K corresponding to the line heads 19Y, 19M, 19C, and 19K, and pawls 124 corresponding to the pawls 24 in the front-side recording apparatus. The line printer is still further equipped with an electric motor and a magnetic linear encoder (magnetic linear scale and a magnetic sensor) which correspond to the electric motor 16, the magnetic linear encoder 20 (magnetic linear scale 21 and magnetic sensor 22), and the controller 23.

As shown in FIG. 1, a portion of the recording paper P transported in a state in which it is maintained on the surface of the belt 15 of the front-side recording apparatus 1 passes positions of the line heads 19Y, 19M, 19C, and 19K, and the portion of the recording paper P is delivered such that it moves along the outer circumferential surface of the belt 115 wound around the drum 113 disposed at the upstream side of the line heads 119Y, 119M, 119C, and 119K.

When the recording begins in the double-sided image forming apparatus (the front-side recording apparatus 1 and the rear-side recording apparatus 2) having the above-described structure, the recording paper P is fed to the surface of the drum 13 disposed at the upstream side of the transportation direction in the front-side recording apparatus 1 of FIG. 1 by the gate rollers 17. The recording paper P is in close contact with (attached to) the upper surface of the belt 15 by adherence of the surface of the belt 15.

The belt 15 is driven by the force of the drum 13 at the driving side, and the belt 15 revolves along the movement of the drum 13. Since the movement of the belt 15 on the drum 13 depends on the drum 13, movement of the recording paper P placed on the belt also depends on the drum 13. Here, when the drum 13 having a high inertia rotates at constant speed, the drum 13 stably rotates. Even if the speed change occurs at the driven roller side, rotation of the belt 15 on the drum 13 is stable, which it not likely to result in vibration of the belt 15. Accordingly, belt transportation is also considerably stable, contributing to high quality in fast printing.

Orientation of the belt 15 depends on the drum 13 having a larger winding amount of the drum 13 and the roller 14. Accordingly, even if the speed change occurs at the driven roller side having a smaller diameter, revolving of the belt 15 is stable and meandering of the belt is unlikely to occur.

Although the belt 15 meanders toward the drum 13 and the belt is disposed between the recording paper P and the drum 13, the recording paper 13 eventually rotates by the rotation of the drum. That is, although the belt 15 meanders toward the drum 13 and the recording paper P is placed on the belt 15 while inclining with respect to the belt 15, since the recording paper P is placed without inclination with respect to the drum 13, if the recording paper P is supplied to the surface of the drum 13 in a right posture at a right position, even if the belt 15 on which the recording paper P is placed meanders, the recording paper is stably transported along the rotation of the drum 13.

Since the line printer 11 which is the front-side recording apparatus 1 has a structure in which the recording is performed by a line-recording line head 19, the recording to the surface of the recording paper P progresses while the drum 13 rotates at constant speed. If a serial recording method is adopted, every when a serial recording head is moved in a thrust direction of the drum for scanning, driving and stopping of the drum having a high inertia are repeated and precision of stop positions of the drum deteriorates. In the case of the line head, since the recording can be performed while the drum 13 rotates at constant speed, precision of transportation position of the recording paper P is raised and high quality recording can be performed on the recording paper P by the stable rotation of the drum 13. At this time, the recording is performed fast and printing for a sheet of paper is finished only by a single time of rotation of the drum 13 or two times of rotations of the drum 15 (for example, within 1 to 5 seconds).

The recording paper P having the surface, on which a recording is performed by the line heads 19Y, 19M, 19C, and 19K, is transported while it is placed on the belt 15 at a position corresponding to the roller 14 positioned at the downstream side of the transportation direction of FIG. 1, is separated by curvature separation thanks to the curved surface of the belt 15 at which the curvature of the drum sharply changes according to the diameter of the roller 14, and is delivered to the rear-side recording apparatus 2. The recording paper P is separated (curvature separation) from the belt 15 only by its stiffness which causes the recording paper P attached to the belt 15 to be bent and therefore the recording paper P is separated from the belt 15. Even if some portion of the recording paper P is not separated by curvature separation, the portion can be separated by the separation pawls 24.

As shown in FIG. 1, the printer is structured in a manner such that some portion of the recording paper P, which is delivered to the rear-side recording apparatus 2, is transported to the outer circumferential surface of the belt 115 wound around the drum 113 disposed at the upstream side of the line heads 119Y, 119M, 119C, and 119K in the rear-side recording apparatus 2. The recording paper P with a rear surface on which the recording is performed by the line heads 119Y, 119M, 119C, and 119K is transported while it is placed on the belt 115 at a position corresponding to the roller 114 at the downstream side of the transportation direction of FIG. 1. Then the recording paper P is separated in a curvature separation manner by the curved surface of the belt 15 of which the curvature sharply changes according to the diameter of the roller 114, and is finally discharged out of the printer by being separated by the separation pawls 124.

According to the above-described first embodiment of the invention, it is possible to obtain the following advantages.

(1) Since the recordings by the line head 19 and 119 are performed to the recording paper P which is supplied and particularly to a portion of the recording paper P which is disposed on the drums 13 and 113 having a large diameter and high inertia and rotating stably, it is possible to perform the recording with high precision in recording positions. Since the recording units are the line heads 19 and 119, the recording progresses while the drums 13 and 113 are rotated at constant speed. Accordingly, such a structure results in improvement of the precision in the recording positions. For example, if the recording is performed by a serial recording method, the drum must be intermittently driven. Since the precision of stop positions of the drum having high inertia (precision in paper transportation position) is lowered, recording precision is also lowered. On the other hand, since the recording is performed by the line recording method, the drums 13 and 113 having high inertial may be continuously rotated at constant speed without stopping which causes deterioration of the precision of the recording position in the middle of recording. Accordingly, it is possible to achieve stable rotation of the drum and to ensure high precision of the recording position.

(2) Since the belts 15 and 115 are used for transporting the recording paper P, the transportation of the recording paper P can be achieved by the belts 15 and 115 in a simple manner. Further, although the recording paper P is indirectly placed on the drums 13 and 113 via the belts 15 and 115 rather than directly placed on the outer circumferential surfaces of the drums 13 and 113, some portion of each of the belts 15 and 115 wound around the outer circumferential surface of each of the drums 13, 113 moves along the motion of each of the drums 13 and 113. Accordingly, it is possible to achieve stable transportation of the recording paper P and therefore to perform high quality recording.

(3) Since each of the rollers 14 and 114 having a smaller diameter and each of the drum 13 and 113 form a pair of rotating bodies around which each of the belts 15 and 115 is wound, the recording paper P transported in a state in which it is placed on the belts 15 and 115 after the recording is performed can be separated from the belts 15 and 115 (by curvature separation) at a curved portion of the belt at which the curvature is high in a simple manner, corresponding to the roller 14, 114. For example, the plurality of grip mechanisms provided for separating the recording paper from the drum disclosed in JP-A-2003-94615 is not needed.

(4) Since the diameter of the drums 13 and 113 is set to have a value in a range from 3 to 10 times the diameter of the rollers 14 and 114, it is possible to ensure relatively sufficient inertia of the drums 13 and 113 in comparison with the rollers 14 and 114 while avoiding increasing the size of the printers 11 and 111 attributable to the large size of the drums 13 and 113, and therefore it is possible to realize transportation stability of the recording paper P and improvement of the precision of the recording position with respect to the recording paper P.

(5) Although a portion of each of the belts 15 and 115 which is stretched between each of the drums 13 and 113 and each of the rollers 14 and 114 vibrates or each of the belts 15 and 115 shakes at a predetermined period according to speed change, attributable to the speed change of the rollers 14 and 114 having relatively low inertia, various kinds of vibration and shaking are not transferred to a portion of the recording paper P wound around the drums 13 and 113. Accordingly, such a structure contributes to improvement of the recording quality in the double-sided recording.

### Second Embodiment

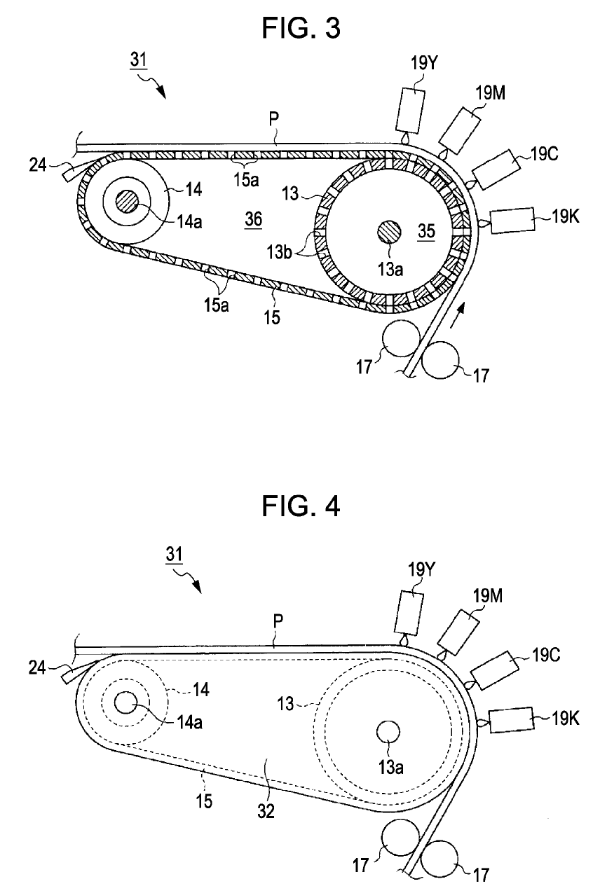

Next, a double-sided image forming apparatus according to a second embodiment will be described with reference to the accompanying drawings FIG. 3 to FIG. 5.

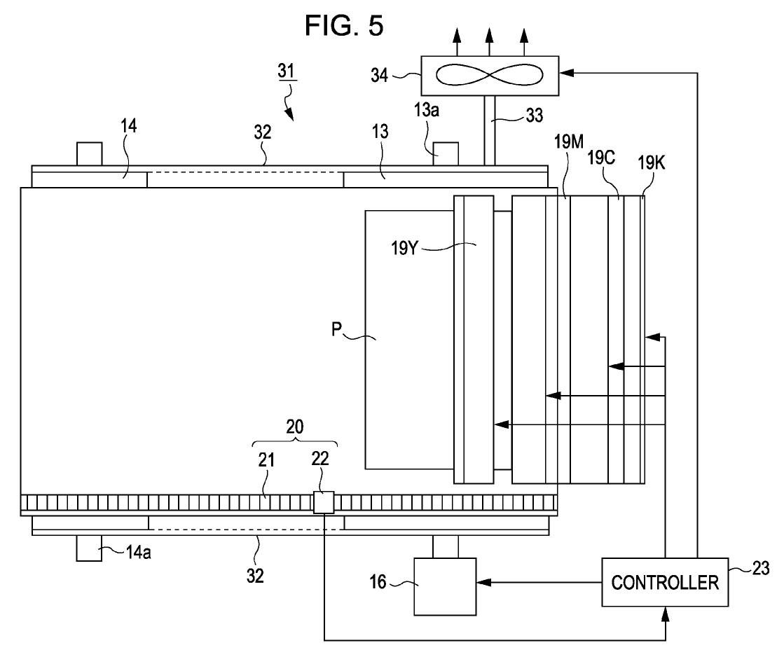

FIG. 3 is a schematic side-sectional view illustrating a front-side recording apparatus of the double-sided image forming apparatus according to the second embodiment, FIG. 4 is a schematic side view, and FIG. 5 is a plan view illustrating the front-side recording apparatus. Since the rear-side recording apparatus of the double-sided image forming apparatus according to the second embodiment basically has the same structure as the front-side recording apparatus, illustration and description thereof will be omitted.

The double-sided image forming apparatus according to the second embodiment is different from the first embodiment from a point of view in which the negative pressure adsorption with respect to the belt is adopted.

A drum 13 in a line printer (hereinafter, simply referred to as printer 31) serving as the front-side recording apparatus 1 is shown in FIG. 3 provided with a plurality of adsorption holes 13b. The adsorption holes 13b in dot form are distributed over the entire area of the outer circumferential surface of the drum 13. The belt 15 is also provided with a plurality of adsorption holes 15a having a dot form over the entire area thereof. As for some portion of the belt 15 wound around the drum 13, even if the winding position of the belt 15 is slightly deviated from the corresponding position of the drum 13, at least some of the adsorption holes 13b at the drum 13 side and the adsorption holes 15a at the belt 15 side communicate with one another. For example, since the adsorption holes 13b and 15a are randomly formed in each of the drum 13 and the belt 15, or the adsorption holes of either the drum 13 or the belt 15 are sufficiently larger than the adsorption holes of the other one.

As shown in FIG. 4 and FIG. 5, both sides of the printer 11 (both sides in a direction which intersects the surface of paper of FIG. 4) are closed by left and right side plates 32 so that air does not leak from the printer except from a portion through which air is discharged from the drum 13. Gap between the side plates 32 and movable parts, such as the drum 13, the roller 14, and the belt 15 is sealed using known sealing means, such as a contact seal or a labyrinth structure.

As shown in FIG. 5, one end of a pipe 33 which communicates with the inside of the drum 13 is connected to either one of the side plates 32 (at an upper side of FIG. 5) and the other end of the pipe 33 is connected to a fan 34. Since the fan 34 is driven and rotated by the controller 23, air in a drum chamber 35 inside the drum 13 is vacuumed and discharged out of the drum chamber 35 and the inside of the drum 13 is maintained at a negative pressure. A belt chamber 36 which is a closed spaced surrounded by the belt 15, the left and right side plates 32, the drum 13, and the roller 14 communicates with the inside of the drum 13 via the adsorption holes 13b. Accordingly, when the drum 13 is in a negative pressure state, the inside of the belt 36 also becomes the negative pressure state.

Air current which directs toward the belt chamber 36 from the outer circumferential surface side of the belt 15 flows through the adsorption holes 15a of the belt 15 by the negative pressure of the inside space of the belt chamber 36, and the recording paper P is transported after the recording is performed in a state in which the recording paper P is adsorbed to the upper surface of an upper portion of the belt 15. Accordingly, of the recording paper P, a portion of the recording paper P, which is transported in a state in which the recording paper is placed on the belt 15 after the recording is performed, is stably transported while the recording paper P does not wind up from the upper surface of the belt 15 although it is exposed to the air current (wind) with predetermined force of wind. For such a reason, some portion of the recording paper P on which the recording is finished winds up from the belt 15, and some portion of the recording paper on which the recording is being performed and the other portion of the recording paper on which the recording is to be performed may not be misaligned with the drum 13.

The printer has a structure in which the recording paper P is adsorbed to the upper surface of the belt 15. Further, since the recording paper P can be placed on the adsorbing surface of the belt 15 which is at the lower side of the gravity direction, the gate rollers 17 are placed at the lower side of the drum 13 than the placement position of the first embodiment. As a result, the paper feeding position of the recording paper P with respect to the drum 13 is shifted to a sufficiently lower side on the outer circumferential surface of the drum 13, the winding amount of the recording paper P, which is wound around the drum, in the circumferential direction of the drum 13 is increased.

In the printer 11, air is discharged out of the drum 13 by driving the fan 34 and air current which directs toward an inner circumferential side from an outer circumferential side of the adsorption holes 13b and 15a which are openings formed in the drum 13 and the belt 15 is created. Accordingly, the recording paper P is transported while it is adsorbed onto the surface of the belt 15. With such a structure, since the problem with position misalignment between the recording paper P and the drum 13 is solved, it is possible to achieve stable transportation of the recording paper P.

When the recording paper P is transported to a position corresponding to the roller 14 positioned at the downstream side of the transportation direction (at the left side of FIG. 3), the adsorption holes 15a in the portion of the belt wound around the roller 14 are closed by the outer circumferential surface of the roller 14 and therefore adsorbing force cannot reach the recording paper P on the belt 15. Accordingly, it is possible to easily separate the recording paper P from the belt 15 by the decreased adsorbing force attributable to the closed state of the adsorption holes 15a and the curvature separation by the roller 14. As in the first embodiment, since the separation pawls 24 are provided, even if there is some portion of the recording paper P, which has not been separated by the curvature separation, the unseparated portion can be surely separated by the separation pawls 24.

According to the second embodiment, the following advantages can be obtained.

(6) The inside of the drum 13 comes to have a negative pressure by the drive of the fan 34, and the recording paper P is adsorbed to some portion of the surface of the belt 15 which is wound around the drum 13 thanks to the adsorption holes 13b and 15a formed in both of the drum 13 and the belt 15. Accordingly, it is possible to surely avoid the positional misalignment between the drum 13 and the recording paper P. Accordingly, it is possible to maintain high precision of recording position with respect to the recording paper P.

(7) Since the belt chamber 36 which communicates with the inside of the drum 13 (drum chamber 35) through the adsorption holes 13b becomes a negative pressure, it is possible to transport the recording paper P in a state in which the recording paper P is adsorbed to the surface of the belt 15 after the recording is finished. However, at the portion of the recording paper P which is separated from the belt by the curvature separation, the recording paper P can be easily separated from the belt by the curvature separation since the adsorption holes 15a of the belt 15 are closed by the outer circumferential surface of the roller 14 and therefore the adsorbing force cannot be imparted to the recording paper P on the belt 15.

(8) Since the recording paper P is adsorbed to the surface of the belt 15, it is possible to place the recording paper P even on the adsorbing surface which is the lower side of the belt 15 in the gravity direction, and therefore it is possible to increase winding amount of the belt 15 and the recording paper P with respect to the outer circumferential surface of the drum 13 in the circumference direction of the drum 13. Accordingly, it is possible to increase an area of the outer circumferential surface of the drum 13 at which the drum 13 and the line heads 19 face each other and the recording paper P is wound around. Accordingly, it is possible to respond to the need for arrangement of a plural number of line heads 19 so as to correspond to five or more colors, and also it is possible to improve the degree of freedom when selecting the arrangement of the line heads 19 in the case in which the number of the line heads is small.

### Third Embodiment

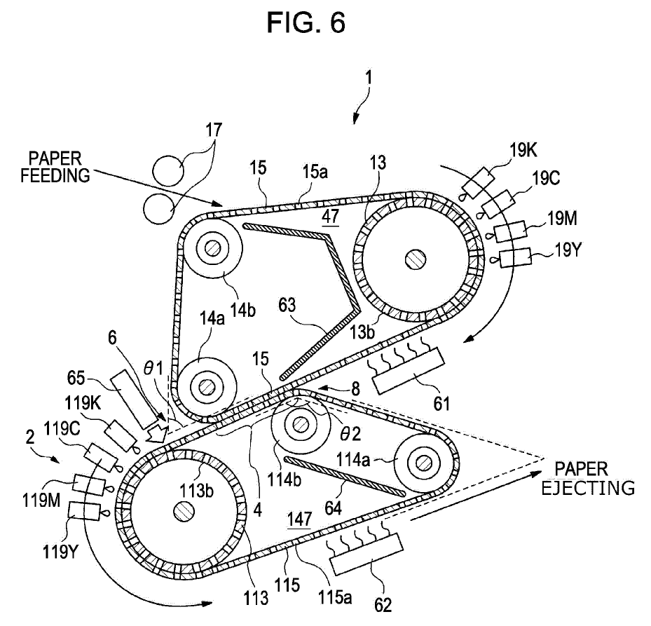

Next, a double-sided image forming apparatus according to a third embodiment of the invention will be described with reference to FIG. 6. FIG. 6 is a schematic side sectional view illustrating the double-sided image forming apparatus according to the third embodiment.

As shown in FIG. 6, the double-sided image forming apparatus according this embodiment is equipped with a line-recording front-side recording apparatus 1 and a line-recording rear-side recording apparatus 2 which are arranged in the transportation direction of the recording paper P like the above-mentioned embodiments. With this embodiment, both of the front-side recording apparatus 1 or the rear-side recording apparatus 2 may have a structure of including one drum 13, 113 and two rollers. That is, the front-side recording apparatus 1 includes a first roller 14a and a second roller 14b and the rear-side recording apparatus 2 includes a first roller 114a and a second roller 114b. That is, both of the front-side recording apparatus 1 and the rear-side recording apparatus 2 have a three-axis structure.

A delivery portion 4 at which the recording paper P is delivered is structured such that the surface of each of the belts 15 and 115 of the front-side recording apparatus 1 and the rear-side recording apparatus 2 is placed to be in direct plane contact with the recording paper P by a predetermined area in the transportation direction.

The delivery portion 4 is disposed at an area between the roller 14a of the front-side recording apparatus 1 which constitutes a separation portion 6 of the recording paper P and the roller 114b of the rear-side recording apparatus 2 which constitutes an introduction portion 8 of the recording paper P. An angle θ1 of the belt 15 wound around the roller 14a which constitutes the separation portion 6 is an acute angle with respect to the roller 14a, and an angle θ2 of the belt wound around the roller 114b which constitutes the introduction portion 8 is an obtuse angle with respect to the roller 114b.

With this embodiment, belt transportation speed V2 of the rear-side recording apparatus 2 is slightly faster than belt transportation speed V1 of the front-side recording apparatus 1. A halogen lamp serving as dry means 61 is disposed at an area between the line head 19 of the front-side recording apparatus and the roller 114b of the rear-side recording apparatus 2 which constitutes the introduction portion 8. Another dry means 62 is disposed at the downstream side of the drum 113. Instead of the halogen lamp, the dry means 61 may be constituted as an optical dry machine, such as a xenon lamp, a mercury lamp or a LED lamp which emits ultraviolet rays which cures UV-curable ink, heat of radiation, air of room temperature, and hot air of 60 to 250° C.

In the front-side recording apparatus 1, a space 47 disposed at a more inner side than the inner circumferential surface of the belt 15 and disposed outside the drum 13 is provided with a barrier wall portion 63 which demarcates a portion of the space 47 in which adsorption force can be imparted to the adsorption holes 15a of the portion of the belt 15 ranging from an ending point of the winding of the belt 15 with respect to the drum 13 to a beginning point of the winding of the belt 15 with respect to the roller 14a by the negative pressure caused by discharging the air in the drum 13 out of the drum 13 through the adsorption holes 13b of the drum 13. In the rear-side recording apparatus 2, a space 147 disposed at a more inner side than the inner circumferential surface of the belt 115 and disposed outside the drum 113 is provided with a barrier wall portion 64 which demarcates a portion of the space 147 in which adsorption force can be imparted to the adsorption holes 115a of the portion of the belt 115 ranging from an ending point of the winding of the belt 115 with respect to the drum 113 to a beginning point of the winding of the belt 115 with respect to the roller 114b by the negative pressure caused by discharging the air in the drum 113 out of the drum 113 through the adsorption holes 113b of the drum 113. The spaces 47 and 147 surrounded by at least the barrier wall portions 63 and 64 and the belts 15 and 115, respectively are sealed.

A position behind the delivery portion 4 is provided with the paper leading end detector 65. Since the leading end of the recording paper with the front-side surface on which the recording has been already performed by the front-side recording apparatus 1 is detected by the paper leading end detector 65, the recording paper P can be sent to a recording area of the rear-side recording apparatus 2, and it is possible to perform the rear-side recording with high precision of the recording position.

According to the third embodiment, the following advantages can be achieved.

According to this embodiment, the delivery portion 4 of the recording paper P is placed in a manner such that the recording paper P is in plane contact with the surface of each of the belts 15 and 115 of the front-side recording apparatus 1 and the rear-side recording apparatus 2 in the transportation direction. Accordingly, the recording paper P is in a state in which it is supported by the belts 15 and 115 from both of the front side and the rear side thereof at the delivery portion 4, and then falls to a state in which it is supported only by the belt 115 of the rear-side recording apparatus 2. Therefore, the recording paper P is smoothly delivered to the belt 115 of the rear-side recording apparatus 2 from the belt 15 of the front-side recording apparatus 1, and it is possible to prevent the recording quality from deteriorating which is likely to occur in the middle of delivering.

Further, since the rear-side recording apparatus 2 has a three-axis structure in which a number of the drum 113 is one and a number of the rollers 114a and 114b is two, the degree of design freedom in the entire structure is increased, and it is possible to easily reserve a space for installing various members, such as the dry means 61 and the paper leading end detector 65 therein.

Further, the delivery portion 4 is provided at an area between the roller 14a of the front-side recording apparatus 1 which constitutes a separation portion 6 and the roller 114b of the rear-side recording apparatus 2 which constitutes an introduction portion 8 of the recording paper P, an angle of the belt wound around the roller 14a which constitutes the separation portion 6 is an acute angle with respect to the roller 14a, and an angle θ1 of the belt wound around the roller 114b which constitutes the introduction portion is an obtuse angle with respect to the roller 114b. Accordingly, when the recording paper P with the front-side surface on which the recording is finished by the front-side recording apparatus 1 is transported toward the rear-side recording apparatus 2 and approaches the delivery portion 4, even if a leading end of the recording paper P is lifted, the lifting of the recording paper P is easily corrected by the obtuse angle structure, and then the recording paper P enters the delivery portion 4. At an exit portion of the delivery portion 4, the recording paper P can be smoothly moved in a state in which it is supported only by the belt 115 of the rear-side recording apparatus 2.

Further, since the belt transportation speed V2 of the rear-side recording apparatus 2 is slightly faster than the belt transportation speed V1 of the front-side recording apparatus 1, it is possible to prevent occurrence of undesirable jamming attributable to the difference between the transportation speeds of both belts (including the reversed relationship between the transportation speeds of both belts).

With this embodiment, the belt transportation speed V2 of the rear-side recording apparatus 2 is faster than the belt transportation speed V1 of the front-side recording apparatus 1. Accordingly, contact load to the surface of the recording paper on which the recording is finished is increased on the basis of the speed difference. However, since the recorded surface of the recording paper have been dried already by the dry means 61, it is possible to prevent deterioration of the recording quality which is attributable to the increase of the contact load.

According to this embodiment, since a space 47, 147 which is disposed at the inner side than the outer circumferential surface of the belt 15, 115 and disposed outside the drum 13, 113 is divided by a barrier wall portion 63, 64, it is possible to concentrate the negative pressure to the adsorption holes 15a of some portion of the belt 15, ranging from a position at the downstream side of the drum 13 to a position at which the belt 15 is wound around the roller 14a in the front-side recording apparatus 1, and to the adsorption holes 115a of some portion of the belt 115, ranging from a position at the down stream side of the drum 113 to a position at which the belt 115 is wound around the roller 114b in the rear-side recording apparatus 2. Accordingly, it is possible to smoothly perform the delivery of the recording paper P.

### Other Embodiments

The double-sided image forming apparatus according to the invention is not limited to the ink-jet printer but may be applied to a thermal transfer printer, or to a copying machine.

The liquid ejection type image forming apparatus is not limited to the ink-jet type printer. The liquid ejection type image forming apparatus can be embodied to a fluid ejection apparatus which ejects and discharges liquids as well as ink (liquid, liquid material in which functional material powder is mixed, fluid such as gel, and solid which can flow and be ejected as liquid (for example, powder such as toner). For example, the invention may be applied to a liquid material ejection apparatus which discharges a liquid material containing an electrode material or a color material (pixel material) used for manufacturing a liquid crystal display, an electroluminescence (EL) display, and a surface light emission display in a dispersed form or a dissolved form, a liquid ejection apparatus which discharges a transparent resin solution such as ultraviolet-curable resin for forming fine semispherical lenses (optical lenses) used in optical communication elements on a substrate, a liquid ejection apparatus for ejecting an etching solution, such as acid or base used for etching a substrate, and a liquid ejection apparatus which ejects a liquid material, such as gel (for example, physical gel). Like each of these apparatuses, a predetermined pattern (wiring pattern, electrode pattern, pixel pattern, etching pattern, and arrangement pattern) formed by driving the ejected liquid to the recording medium, such as substrate is contained in an image formed by the recording. The “fluid” is a term containing a fluid composed of only gas and includes liquid (inorganic solvent, organic solvent, solution, liquid-state resin, liquid-state metal (melted metal)), power, and fluid material.

What is claimed is:

1. A double-sided image forming apparatus comprising:
a line-recording front-side image forming apparatus; and
a line-recording rear-side image forming apparatus, the line-recording front-side image forming apparatus and the line-recording rear-side image forming apparatus arranged in a transportation direction of a recording medium,
wherein each of the front-side image forming apparatus and the rear-side image forming apparatus includes:
a drum;
a roller having a smaller diameter than the drum;
an endless belt wound around the drum and the roller;
a driving power source which transports the belt by rotating the drum; and
a line-recording recording unit placed to face an outer circumferential surface of the drum so as to be able to perform recording with respect to the recording medium which is laid on the outer circumferential surface of some portion of the belt which is wound around the drum,
wherein the recording medium transported held on a surface of the belt of the front-side image forming apparatus is delivered in a manner such that a portion of the recording medium which has passed a position of the recording unit is delivered over to an outer circumferential surface of a portion of the belt which is wound around the drum at the upstream side than the recording unit of the rear-side recording apparatus.

2. The double-sided image forming apparatus according to claim 1,
wherein a delivery portion at which the recording medium is delivered is placed in a manner such that the recording medium is in plane contact with the surface of each of the belts of the front-side image forming apparatus and the rear-side image forming apparatus by a predetermined are in the transporting direction.

3. The double-sided image forming apparatus according to claim 2,
wherein the rear-side image forming apparatus includes one drum and two rollers;
wherein the delivery portion is disposed at an area between a roller of the front-side image forming apparatus which constitutes a separating portion of the recording medium and a roller of the rear-side image forming apparatus which constitutes an introduction portion of the recording medium; and
wherein an angle of the belt wound around the roller constituting the separating portion is an acute angle and an angle of the belt wound around the roller constituting the introduction portion is an obtuse angle.

4. The double-sided image forming apparatus according to claim 2,
wherein transportation speed of the belt of the rear-side image forming apparatus is higher than that of the belt of the front-side image forming apparatus.

5. The double-sided image forming apparatus according to claim 4, further comprising a drying unit disposed at an area between the recording unit of the front-side image forming apparatus and the roller of the rear-side image forming apparatus which constitutes the introduction portion of the rear-side image forming apparatus.

6. The double-sided image forming apparatus according to claim 1,
wherein a diameter of the drum is 3 to 10 larger times than that of the roller.

7. The double-sided image forming apparatus according to claim 1, further comprising a negative pressure unit which causes at least a portion of the belt which is wound around the drum to adsorb the recording medium by negative pressure.

8. The double-sided image forming apparatus according to claim 7,
wherein the front-side image forming apparatus is provided with a space disposed at a more inner side of an inner circumferential surface of the belt and at an outer side of the drum, in which the space is provided with a barrier wall which demarcates a portion of the space in which adsorption force, generated by a negative pressure generated by discharging gas out of the drum through adsorption holes of the drum, exerts influence on the adsorption holes of some portion of the belt, ranging from an ending position of a winding of the belt around the drum to a beginning position of a winding of the bent around the roller;
wherein the rear-side image forming apparatus is provided with a space disposed at a more inner side of an inner circumferential surface of the belt and at an outer side of the drum, in which the space is provided with a barrier wall which demarcates a portion of the space in which adsorption force, generated by a negative pressure generated by discharging gas out of the drum through adsorption holes of the drum, exerts influence on the adsorption holes of some portion of the belt, ranging from an ending position of a winding of the belt around the drum to a beginning position of a winding of the bent around the roller; and
wherein at least a space surrounded by the barrier wall and the belt is maintained in a sealed state.
